(19) United States
(12) Patent Application Publication
(10) Pub. No.: US 2023/0364729 A1
(43) Pub. Date: Nov. 16, 2023

(54) MACHINE TOOL

(71) Applicant: FANUC CORPORATION, Minamitsuru-gun, Yamanashi (JP)

(72) Inventor: Toshifumi MURAMATSU, Minamitsuru-gun, Yamanashi-ken (JP)

(73) Assignee: FANUC CORPORATION, Minamitsuru-gun, Yamanashi (JP)

(21) Appl. No.: 18/029,258

(22) PCT Filed: Sep. 24, 2021
(86) PCT No.: PCT/JP2021/034930

§ 371 Date: Mar. 29, 2023

(30) Foreign Application Priority Data
Sep. 30, 2020 (JP) 2020-165407

(51) Int. Cl. B23Q 17/12; G01M 1/14

(52) U.S. Cl. CPC B23Q 17/12; G01M 1/14

(57) ABSTRACT

This machine tool comprises: a motor; a motor driving unit; an encoder which detects the rotation speed of the rotary shaft of the motor; a vibration sensor which detects a vibration amount; an acquisition unit which acquires the vibration amount detected by the vibration sensor at the time of a specified rotation speed; and a display control unit which associates the specified rotation speed with the vibration amount and causes a display unit to display the associated result.

### TECHNICAL FIELD

The present invention relates to a machine tool for machining a workpiece using a tool.

### BACKGROUND ART

A machine tool is provided with a rotating body such as a shaft. A field balancer is known as a device for observing the amount of unbalance in a case where the rotating body is regarded as a rigid rotor or an elastic rotor. This amount of unbalance is referred to as a state of balance (a balance state). JP H03-251066 A discloses that the balance state of rotation of a rotating observation target is observed. By observing the balance state of the rotating body, an operator can know how to correct the balance state of the rotating body when the balance state of the rotating body adversely affects the operation of the machine.

### SUMMARY OF THE INVENTION

However, the observation accuracy with which the field balancer observes the balance state of the rotating body depends on how to attach the field balancer to the machine tool or an attachment position at which the field balancer is attached to the machine tool. Therefore, it is not always easy for the operator to stably and accurately observe the balance state of the rotating body by the field balancer. Also, it is not always easy for the operator to perform the balance correction operation.

Therefore, an object of the present invention is to provide a machine tool capable of observing a balance state of a rotating body of a machine tool without a field balancer and facilitating adjustment operation of the balance state.

According to a first aspect of the present invention, there is provided a machine tool that machines a workpiece using a tool, the machine tool including: a motor including a rotation shaft; a motor drive unit configured to drive the motor; an encoder provided in the motor and configured to detect a rotation speed of the rotation shaft; a vibration sensor provided in the machine tool and configured to detect an amount of vibration generated during rotation of the rotation shaft; an acquisition unit configured to acquire the amount of vibration detected by the vibration sensor when the rotation speed detected by the encoder is a specified rotation speed that is predetermined; and a display control unit configured to cause a display unit to display the specified rotation speed and the amount of vibration acquired by the acquisition unit, in association with each other.

According to a second aspect of the present invention, there is provided a machine tool that machines a workpiece using a tool, the machine tool including: a motor including a rotation shaft; a motor drive unit configured to drive the motor; a current sensor provided in the motor or the motor drive unit and configured to detect a drive current output to the motor; a vibration sensor provided in the machine tool and configured to detect an amount of vibration generated during rotation of the rotation shaft; a speed estimation unit configured to estimate a rotation speed of the rotation shaft based on a signal obtained from the current sensor; an acquisition unit configured to acquire the amount of vibration detected by the vibration sensor when the rotation speed estimated by the speed estimation unit is a specified rotation speed that is predetermined; and a display control unit configured to cause a display unit to display the specified rotation speed and the amount of vibration acquired by the acquisition unit, in association with each other.

According to the present invention, it is possible to observe the balance state of the rotating body of the machine tool, without use of the field balancer, by grasping the vibration amount generated during rotation of the rotating body at the specified rotation speed, with the sensor provided in the machine tool. In addition, the vibration amount generated during rotation of the rotating body at a specified rotation speed and the specified rotation speed are displayed in association with each other, whereby it is possible to support the operator in the adjustment operation for the balance state of the rotating body of the machine tool. In this way, it is possible to provide a machine tool in which the balance state of the rotating body of the machine tool can be observed without using a field balancer and to facilitate the balance state adjustment operation.

### BRIEF DESCRIPTION OF DRAWINGS

FIG. 1 is a schematic view of a machine tool according to an embodiment of the present invention;

FIG. 2 is a schematic block diagram showing a control device;

FIG. 3 is a graph illustrating signals output from an encoder;

FIG. 4 is a graph illustrating signals output from a vibration sensor;

FIG. 5 is a graph showing a correspondence relationship between a specified rotation speed and a vibration amount at the specified rotation speed;

FIG. 6 is a schematic diagram illustrating a machine tool according to a first modification; and

FIG. 7 is a schematic diagram showing a machine tool according to a second modification.

### DETAILED DESCRIPTION OF THE INVENTION

### Embodiment

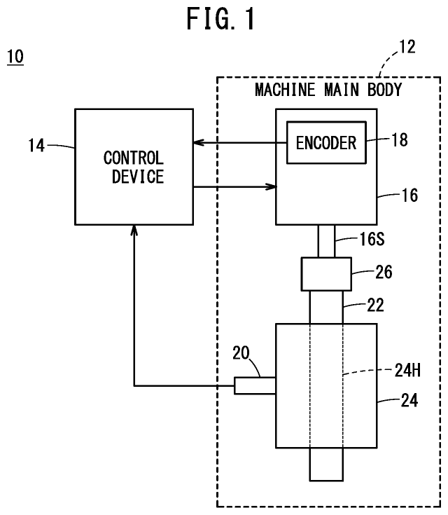

FIG. 1 is a schematic view of a machine tool 10 according to an embodiment of the present invention. The machine tool 10 machines a workpiece (an object to be machined) by using a tool. The machine tool 10 may be a precision machine tool capable of controlling a motor with nanoscale resolution, according to a machining command. The machine tool 10 may be an ultra-high precision machine tool capable of controlling a motor with one-tenth nanoscale resolution according to a machining command. Examples of the machine tool 10 include a lathe machine that machines a rotating workpiece by bringing the workpiece into contact with a fixed tool. The machine tool 10 may be a machining center or the like that machines a fixed workpiece by bringing a rotating tool into contact with the workpiece. The machine tool 10 includes a machine main body 12 and a control device 14 that controls the machine main body 12.

The machine main body 12 includes a machine unit. The machine main body 12 further includes devices such as a motor, a sensor, etc. mounted on the machine unit. The machine main body 12 is provided with a motor 16, an encoder 18, and a vibration sensor 20.

The motor 16 has a rotation shaft 16S. The motor 16 further includes a rotor (not shown) and a stator (not shown). When a drive current output from the control device 14 flows through the coil of the stator, the rotor rotates. When the rotor rotates, the rotation shaft 16S of the motor 16 rotates integrally with the rotating rotor.

A rotating body that rotates based on the power of the motor 16 is attached to one end of the rotation shaft 16S of the motor 16. The rotating body is not particularly limited as long as it is a mechanical component included in the machine main body 12. Examples of the rotating body include a spindle 22, a tool, and the like. In the present embodiment, the rotating body is the spindle 22.

The spindle 22 is inserted into a through hole 24H of a housing 24. The rotation shaft 16S of the motor 16 is attached to a first end portion which is one of both the end portions of the spindle 22 via a joint 26. The rotating body may include a component attached to a second end portion which is the other of both the end portions of the spindle 22. For example, when the machine tool 10 is a lathe machine, the rotating body includes a face plate attached to the second end portion. The face plate is a component for fixing a workpiece. As another example, when the machine tool 10 is a machining center, the rotating body includes a tool attached to the second end portion. The tool is a component for machining a workpiece.

The encoder 18 detects a rotation speed of the rotation shaft 16S of the motor 16. The encoder 18 is provided in the motor 16. Signals output from the encoder 18 are input to the control device 14.

The vibration sensor 20 detects an amount of vibration (vibration amount) occurring when the rotation shaft 16S of the motor 16 rotates. Examples of the vibration amount include acceleration, speed, displacement, angular acceleration, angular velocity, and angle. As the vibration sensor 20, a known sensor capable of detecting acceleration, speed, displacement, angular acceleration, angular velocity, or angle is used.

The vibration sensor 20 is provided in the machine main body 12. The installation location of the vibration sensor 20 is not particularly limited as long as it allows the sensor to detect the amount of vibration (vibration amount) occurring when the rotation shaft 16S of the motor 16 is rotating. In the example of FIG. 1, the vibration sensor 20 is provided on the housing 24 of the spindle 22 in the machine main body 12. Alternatively, the vibration sensor 20 may be provided on the spindle 22.

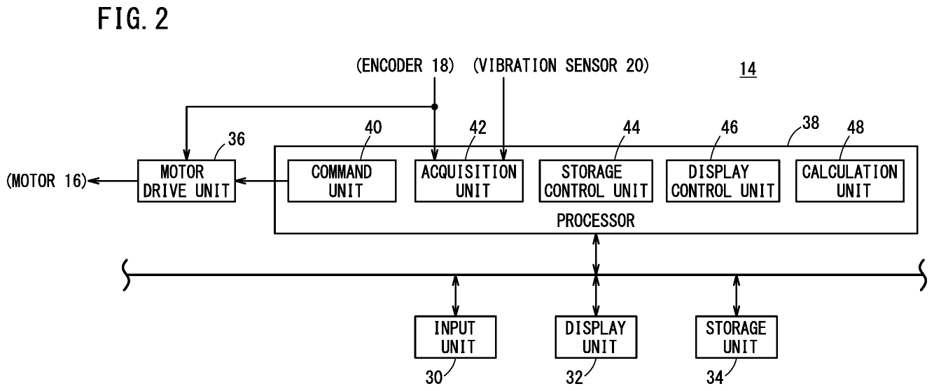

FIG. 2 is a schematic block diagram showing the control device 14. The control device 14 includes an input unit 30, a display unit 32, a storage unit 34, a motor drive unit 36, and a processor 38.

The input unit 30 is used to input information. Specific examples of the input unit 30 include a mouse, a keyboard, and the like. The input unit 30 may be configured by a touch panel or the like disposed on the display screen of the display unit 32. The display unit 32 serves to display information. Specific examples of the display unit 32 include a liquid crystal display, for example. The display unit 32 displays a screen or the like based on information provided from the processor 38. The storage unit 34 serves to store information. The storage unit 34 may include a volatile memory and a nonvolatile memory, neither of which are shown. Examples of the volatile memory include a RAM (random access memory) or the like. Examples of the nonvolatile memory include a ROM (read only memory), a flash memory, or the like. At least a part of the storage unit 34 may be provided in the processor 38 or the like. The storage unit 34 may further include a hard disk or the like.

The motor drive unit 36 drives the motor 16. A specific example of the motor drive unit 36 is a servo amplifier. The motor drive unit 36 outputs a drive current to the motor 16 such that the motor 16 rotates at a rotation speed corresponding to a command value supplied from the processor 38.

The processor 38 serves to process information. Specific examples of the processor 38 include a CPU (central processing unit), a GPU (graphics processor unit), and the like. The processor 38 has a machining mode for machining a workpiece and a support mode for supporting adjustment operation for adjusting a balance state (a balance state adjustment operation).

The balance state means the following first state or second state. The first state is the amount of static unbalance and couple unbalance. The second state is the amount of unbalance due to modal behavior of a rotating body. When the balance state means the first state, the rotor that rotates integrally with the rotation shaft 16S of the motor 16 is regarded as a rigid rotor. Alternatively, when the balance state means the first state, the rotation shaft 16S of the motor 16 and the rotor that rotates integrally with the rotation shaft 16S of the motor 16 may be regarded as a rigid rotor. When the balance state means the second state, the rotor that rotates integrally with the rotation shaft 16S of the motor 16 is regarded as an elastic rotor. Alternatively, when the balance state means the second state, the rotation shaft 16S of the motor 16 and the rotor that rotates integrally with the rotation shaft 16S of the motor 16 may be regarded as an elastic rotor. The adjustment operation means adjustment work for performing adjustment so as to reduce the amount of the first state or the second state. Specific examples of the adjustment operation include work for shaving a rotor or the like. In addition, specific examples of the adjustment operation include work for attaching a balance weight to a rotor or the like.

The support mode is performed before and after the balance state adjustment operation. The number of times of the balance state adjustment operation is not limited to one. When the adjustment operation of the balance state is performed a plurality of times, the support mode is performed before the adjustment operation and after each adjustment operation.

Upon receiving a command to execute the support mode, from the input unit 30, the processor 38 functions as a command unit 40, an acquisition unit 42, a storage control unit 44, a display control unit 46, and a calculation unit 48 on the basis of a program for executing the support mode. The program for executing the support mode is stored in the storage unit 34.

The command unit 40 outputs a specified rotation speed as a command value to the motor drive unit 36. Upon receiving the command value, the motor drive unit 36 drives the motor 16 so as to rotate at the specified rotation speed. That is, the command unit 40 outputs the specified rotation speed as a command value to the motor drive unit 36, and thereby can generate, in the rotation shaft 16S of the motor 16, vibration necessary for observing the balance state of the rotating body (the spindle 22 in the present embodiment) of the machine tool 10.

Note that the number of such specified rotation speeds may be one or more. When the number of the specified rotation speeds is plural, the command unit 40 sequentially outputs each of the plurality of specified rotation speeds as a command value, to the motor drive unit 36 at time intervals. In this case, the command unit 40 may output each of the plurality of specified rotation speeds as a command value to the motor drive unit 36 such that the rotation speed of the rotation shaft 16S gradually increases. Alternatively, the command unit 40 may output each of the plurality of specified rotation speeds as a command value to the motor drive unit 36 such that the rotation speed of the rotation shaft 16S gradually decreases.

Based on signals output from the encoder 18, the acquisition unit 42 determines whether or not the rotation speed detected by the encoder 18 is the specified rotation speed that has been output as the command value by the command unit 40 to the motor drive unit 36.

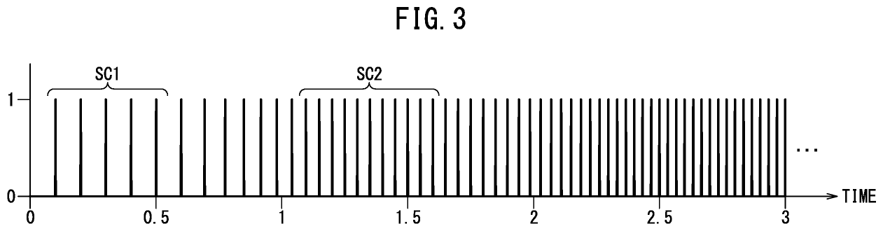

FIG. 3 is a graph illustrating signals output from the encoder 18. FIG. 3 shows an example of pulse signals in which one pulse is output from the encoder 18 each time the rotation shaft 16S of the motor 16 makes one rotation. FIG. 3 shows an example of a case where the specified rotation speed is specified as 600 rpm and 1200 rpm. In this example, the acquisition unit 42 determines that the rotation speed detected by the encoder 18 is the specified rotation speed (600 rpm), in a case of a section SC1 in which one pulse is output every 0.1 seconds. Further, in a case of an interval SC2 in which one pulse is output every 0.05 seconds, the acquisition unit 42 determines that the rotation speed detected by the encoder 18 is the specified rotation speed (1200 rpm). Although FIG. 3 illustrates a case where the rotation speed of the rotation shaft 16S is gradually increased, the rotation speed may be gradually decreased.

The acquisition unit 42 acquires the vibration amount when it is determined that the rotation speed is the specified rotation speed, based on the signals output from the vibration sensor 20.

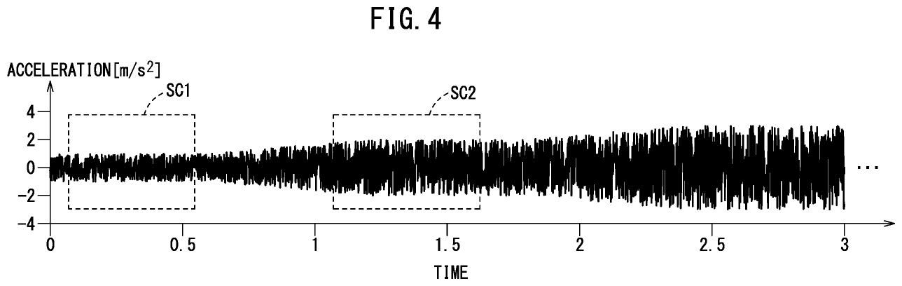

FIG. 4 is a graph illustrating signals output from the vibration sensor 20. FIG. 4 shows an example in which an acceleration sensor is used as the vibration sensor 20. In this case, the acquisition unit 42 calculates the root mean square of the vibration amounts (accelerations) detected by the vibration sensor 20 in the section SC1, and acquires the calculated root mean square as the vibration amount in the section SC1. The acquisition unit 42 calculates the root mean square of the vibration amounts (accelerations) detected by the vibration sensor 20 in the section SC2, and acquires the calculated root mean square as the vibration amount in the section SC2.

The acquisition unit 42 may acquire a statistical value other than the root mean square as the vibration amount of the section SC1 or the section SC2. Examples of the statistical value include a standard deviation or the like of vibration amounts (accelerations) detected by the vibration sensor 20 in the section SC1 or the section SC2. Alternatively, examples of the statistical value include an average or the like of absolute values of vibration amounts (accelerations) detected by the vibration sensor 20 in the section SC1 or the section SC2. The acquisition unit 42 may acquire a predetermined value such as a maximum value or the like among absolute values of vibration amounts (accelerations) detected by the vibration sensor 20 in the section SC1 or the section SC2 as the vibration amount in the section SC1 or the section SC2. The acquisition unit 42 may extract components synchronized with the rotation speed, from the vibration amounts (accelerations) detected by the vibration sensor 20 in the section SC1 or the section SC2, and acquire the amplitude or phase of the synchronized components, as the vibration amount in the section SC1 or the section SC2.

In this way, the acquisition unit 42 acquires the vibration amount when the rotation speed detected by the encoder 18 is the specified rotation speed that has been output as the command value by the command unit 40 to the motor drive unit 36.

The storage control unit 44 stores, in the storage unit 34, the specified rotation speed and the vibration amount acquired by the acquisition unit 42, as a history, in association with the date on which the vibration amount was acquired. The vibration amount acquired by the acquisition unit 42 is a vibration amount acquired by the acquisition unit 42 during rotation of the rotation shaft 16S at the specified rotation speed.

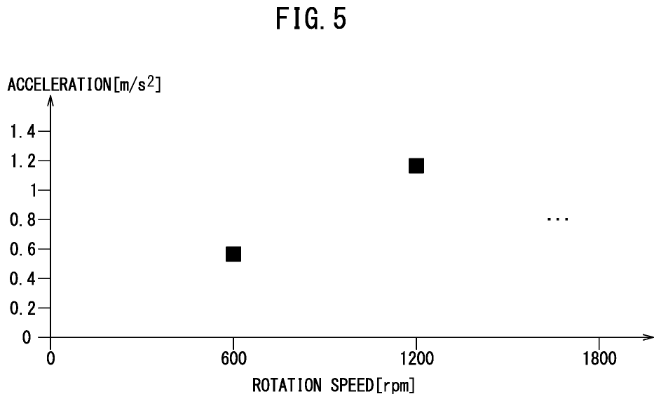

FIG. 5 is a graph showing a correspondence relationship between a specified rotation speed and a vibration amount occurring at the specified rotation speed. FIG. 5 shows an example in which an acceleration sensor is used as the vibration sensor 20. FIG. 5 shows an example of a case where the specified rotation speed is specified as 600 rpm and 1200 rpm. FIG. 5 illustrates an example in which the vibration amount is 0.58 m/s² when the specified rotation speed is 600 rpm and the vibration amount is 1.18 m/s² when the specified rotation speed is 1200 rpm. In this case, the storage control unit 44 stores the specified rotation speed 600 rpm and the vibration amount 0.58 m/s² in association with the date, for example, in the relational table of the storage unit 34. Further, the storage control unit 44 stores the specified rotation speed 1200 rpm and the vibration amount 1.18 m/s² in association with the date, in the relational table of the storage unit 34.

The display control unit 46 refers to the storage unit 34 and causes the display unit 32 to display the specified rotation speed and the vibration amount associated with the date. The vibration amount is a vibration amount acquired by the acquisition unit 42 during rotation of the rotation shaft 16S at the specified rotation speed.

A display format in which the display control unit 46 causes the display unit 32 to display the specified rotation speed and the vibration amount is not particularly limited. For example, the display control unit 46 may cause the display unit 32 to display the numerical value of the specified rotation speed and the numerical value of the vibration amount. Alternatively, as illustrated in FIG. 5, the display control unit 46 may cause the display unit 32 to display a graph in which one of the specified rotation speed and the vibration amount is a vertical axis and the other is a horizontal axis. When displaying the graph, the display control unit 46 plots data on the graph, based on the vibration amount acquired by the acquisition unit 42 while the rotation shaft 16S is rotating at the specified rotation speed.

The display timing at which the display control unit 46 causes the display unit 32 to display the specified rotation speed and the vibration amount is not particularly limited. For example, the display control unit 46 may cause the display unit 32 to display the specified rotation speed and the vibration amount at a time point at which a display request is received from the input unit 30. Alternatively, the display control unit 46 may cause the display unit 32 to display the specified rotation speed and the vibration amount at a time point at which the acquisition unit 42 acquires the vibration amount.

When the support mode was executed in the past, the storage unit 34 stores, for each date of the support mode executed in the past, the vibration amount acquired by the acquisition unit 42 at the time of execution of the support mode, in association with the specified rotation speed. In this case, the display control unit 46 may cause the display unit 32 to display the vibration amount acquired by the acquisition unit 42 this time and the vibration amount acquired by the acquisition unit 42 in the past, in a manner so that those vibration amounts can be compared with each other.

The calculation unit 48 calculates at least one of a correction angle or a correction amount, based on a difference between the vibration amount stored in the storage unit 34 before the adjustment operation of the balance state and the vibration amount stored in the storage unit 34 after the adjustment operation of the balance state. The correction angle means a rotation angle with which the adjustment operation is to be performed on the rotating body such as a rotor. When the adjustment operation is an operation of shaving a rotor or the like, the correction amount means a shaving amount. When the adjustment operation is an operation of attaching a balance weight to the rotor or the like, the correction amount means a weight amount of the balance weight.

A specific calculation method for the correction angle and the correction amount is not particularly limited. For example, the calculation unit 48 may calculate the correction angle and the correction amount by using a calculation method disclosed in JP 5808585 B2, JP H06-273254 A, or JP 2002-007375 A.

As described above, the machine tool 10 of the present embodiment uses the sensors (the encoder 18 and the vibration sensor 20) provided in the machine main body 12 to acquire the vibration amount generated when the rotation shaft 16S rotates at the specified rotation speed. As a result, it is possible to observe the balance state of the rotating body (spindle 22) attached to the rotation shaft 16S in the machine main body 12, without using the field balancers.

In addition, the machine tool 10 of the present embodiment causes the display unit 32 to display the specified rotation speed and the vibration amount generated when the rotation shaft 16S rotates at the specified rotation speed, in association with each other. With this configuration, it is possible to support the operator in the adjustment operation of the balance state of the rotating body (spindle 22) attached to the rotation shaft 16S.

In addition, the machine tool 10 of the present embodiment calculates at least one of the correction angle or the correction amount for the balance state with respect to the rotation shaft 16S, and displays the calculation result on the display unit 32. Accordingly, the operator can perform the next adjustment operation while looking at and referring to at least one of the difference of the vibration amount between before and after the balance state adjustment operation, the correction angle, or the correction amount. Therefore, it is possible to further facilitate the adjustment operation for the balance state.

### [Modifications]

The above embodiment may be modified as follows.

### (Modification 1)

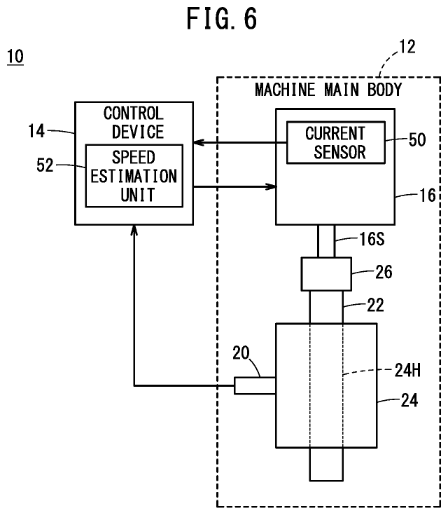

FIG. 6 is a schematic view showing a machine tool 10 according to a first modification. In FIG. 6, the same reference numerals are used to designate constituent elements that are the same as those described in the embodiment. Moreover, in the present exemplary modification, descriptions that overlap or are duplicative of those stated in the embodiment will be omitted. In the present modification, a current sensor 50 is provided instead of the encoder 18, and a speed estimation unit 52 is newly provided in the control device 14.

The current sensor 50 detects a drive current output to the motor 16. The current sensor 50 may be provided in the motor 16 (see FIG. 6) or may be provided in the motor drive unit 36 (see FIG. 2) that drives the motor 16.

The speed estimation unit 52 estimates the rotation speed of the rotation shaft 16S based on the signal obtained from the current sensor 50. A specific calculation method for estimating the rotation speed is not particularly limited. For example, the speed estimation unit 52 may estimate the rotation speed using a calculation method disclosed in JP 2020-005406 A. Therefore, even if the encoder 18 is not provided in the motor 16, the rotation speed of the rotation shaft 16S can be grasped.

In the case of the present modification, the acquisition unit 42 (FIG. 2) determines whether or not the rotation speed estimated by the speed estimation unit 52 is the specified rotation speed that has been output as the command value by the command unit 40 to the motor drive unit 36, based on the signal output from the vibration sensor 20.

As described above, similarly to the embodiment, the machine tool 10 of the present modification uses the sensors (the current sensor 50 and the vibration sensor 20) provided in the machine main body 12 to acquire the vibration amount generated when the rotation shaft 16S rotates at the specified rotation speed. As a result, as in the embodiment, it is possible to observe the balance state of the rotating body (spindle 22) attached to the rotation shaft 16S in the machine main body 12, without using the field balancers.

### (Modification 2)

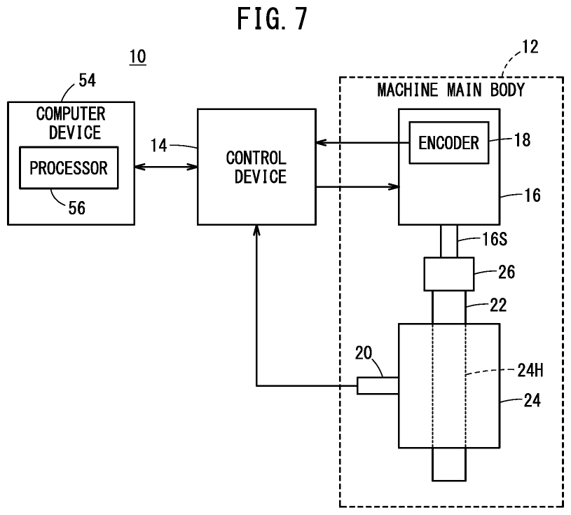

FIG. 7 is a schematic view showing a machine tool 10 according to a second modification. In FIG. 7, the same reference numerals are used to designate constituent elements that are the same as those described in the embodiment. Moreover, in the present exemplary modification, descriptions that overlap or are duplicative of those stated in the embodiment will be omitted.

In the present modification, a computer device 54 that can transmit and receive various types of information is connected to the control device 14. A device other than the computer device 54 may be used as long as the device can be physically separated from the control device 14. Although FIG. 7 illustrates a case where the computer device 54 is connected to the control device 14 of the embodiment, the computer device 54 may be connected to the control device 14 of the first modification.

Further, in the present modification, the command unit 40 (FIG. 2), the acquisition unit 42 (FIG. 2), the storage control unit 44 (FIG. 2), the display control unit 46 (FIG. 2), and the calculation unit 48 (FIG. 2) which are provided in the processor 38 (FIG. 2) of the control device 14 are omitted. Instead thereof, a processor 56 of the computer device 54 is provided with the command unit 40, the acquisition unit 42, the storage control unit 44, the display control unit 46, and the calculation unit 48. For example, by installing a program for executing the support mode in the computer device 54, the processor 56 can be caused to function as the command unit 40, the acquisition unit 42, the storage control unit 44, the display control unit 46, and the calculation unit 48.

According to the present modification, the balance state of the rotating body of the machine tool 10 can be observed, without use of the field balancer, by using the existing control device 14 without modification, and the adjustment operation of the balance state can be facilitated.

[Invention Obtained from the Embodiment]

First and second inventions are described below as inventions that can be grasped from the above embodiment and modifications.

### <First Invention>

The first invention is characterized by the machine tool (10) that machines a workpiece using a tool, the machine tool including: the motor (16) including the rotation shaft (16S); the motor drive unit (36) configured to drive the motor; the encoder (18) provided in the motor and configured to detect the rotation speed of the rotation shaft; the vibration sensor (20) provided in the machine tool and configured to detect the amount of vibration generated during rotation of the rotation shaft; the acquisition unit (42) configured to acquire the amount of vibration detected by the vibration sensor when the rotation speed detected by the encoder is a specified rotation speed that is predetermined; and the display control unit (46) configured to cause the display unit (32) to display the specified rotation speed and the amount of vibration acquired by the acquisition unit, in association with each other.

### <Second Invention>

The second invention is characterized by the machine tool that machines a workpiece using a tool, the machine tool including: the motor including the rotation shaft; the motor drive unit configured to drive the motor; the current sensor (50) provided in the motor or the motor drive unit and configured to detect a drive current output to the motor; the vibration sensor provided in the machine tool and configured to detect the amount of vibration generated during rotation of the rotation shaft; the speed estimation unit (52) configured to estimate the rotation speed of the rotation shaft based on a signal obtained from the current sensor; the acquisition unit configured to acquire the amount of vibration detected by the vibration sensor when the rotation speed estimated by the speed estimation unit is a specified rotation speed that is predetermined; and the display control unit configured to cause the display unit to display the specified rotation speed and the amount of vibration acquired by the acquisition unit, in association with each other.

In the case of the first invention or the second invention, it is possible to observe the balance state of the rotating body of the machine tool, without use of the field balancer, by acquiring the vibration amount generated during rotation of the rotating body at the specified rotation speed with the sensor provided in the machine tool. In addition, the vibration amount generated during rotation of the rotating body at the specified rotation speed and the specified rotation speed are displayed in association with each other, whereby it is possible to support the operator in the adjustment operation of the balance state of the rotating body of the machine tool. Thus, according to the first invention or the second invention, it is possible to observe the balance state of the rotating body of the machine tool without use of the field balancer, and to facilitate the adjustment operation for the balance state.

The machine tool according to the first invention or the second invention may further include: the storage control unit (44) configured to cause the storage unit (34) to store the specified rotation speed and the amount of vibration acquired by the acquisition unit, in association with each other; and the calculation unit (48) configured to calculate at least one of the correction angle or the correction amount for the balance state with respect to the rotation shaft, based on the difference between the amount of vibration stored in the storage unit before the adjustment operation for adjusting the balance state with respect to the rotation shaft and the amount of vibration stored in the storage unit after the adjustment operation, and the display control unit may cause the display unit to display at least one of the difference, the correction angle, or the correction amount. This makes it possible to cause the operator to perform the next adjustment operation while showing, to the operator, at least one of the difference of the vibration amount between before and after the balance state adjustment operation, the correction angle, or the correction amount. Therefore, it is possible to further facilitate the adjustment operation for the balance state.

In the machine tool of the first invention or the second invention, the motor drive unit may be provided in the control device (14) configured to control the machine main body (12), and the acquisition unit and the display control unit may be provided in a device configured to be separated from the control device. With this configuration, the balance state of the rotating body of the machine tool can be observed, without use of the field balancer, by using the existing control device without modification, and the adjustment operation for the balance state can be facilitated.

1. A machine tool that machines a workpiece using a tool, the machine tool comprising:
a motor including a rotation shaft;
a motor drive unit configured to drive the motor;
an encoder provided in the motor and configured to detect a rotation speed of the rotation shaft;
a vibration sensor provided in the machine tool and configured to detect an amount of vibration generated during rotation of the rotation shaft;
an acquisition unit configured to acquire the amount of vibration detected by the vibration sensor when the rotation speed detected by the encoder is a specified rotation speed that is predetermined; and
a display control configured to cause a display unit to display the specified rotation speed and the amount of vibration acquired by the acquisition unit, in association with each other.

2. A machine tool that machines a workpiece using a tool, the machine tool comprising:
a motor including a rotation shaft;
a motor drive unit configured to drive the motor;
a current sensor provided in the motor or the motor drive unit and configured to detect a drive current output to the motor;
a vibration sensor provided in the machine tool and configured to detect an amount of vibration generated during rotation of the rotation shaft;
a speed estimation unit configured to estimate a rotation speed of the rotation shaft based on a signal obtained from the current sensor;
an acquisition unit configured to acquire the amount of vibration detected by the vibration sensor when the rotation speed estimated by the speed estimation unit is a specified rotation speed that is predetermined; and
a display control unit configured to cause a display unit to display the specified rotation speed and the amount of vibration acquired by the acquisition unit, in association with each other.

3. The machine tool according to claim 1, further comprising:
a storage control unit configured to cause a storage unit to store the specified rotation speed and the amount of vibration acquired by the acquisition unit, in association with each other; and
a calculation unit configured to calculate at least one of a correction angle or a correction amount for a balance state with respect to the rotation shaft, based on a difference between the amount of vibration stored in the storage unit before an adjustment operation for adjusting the balance state with respect to the rotation shaft and the amount of vibration stored in the storage unit after the adjustment operation,
wherein the display control unit causes the display unit to display at least one of the difference, the correction angle, or the correction amount.

4. The machine tool according to claim 1, wherein
the motor drive unit is provided in a control device configured to control a machine main body, and
the acquisition unit and the display control unit are provided in a device configured to be separated from the control device.

5. The machine tool according to claim 2, further comprising:
a storage control unit configured to cause a storage unit to store the specified rotation speed and the amount of vibration acquired by the acquisition unit, in association with each other; and
a calculation unit configured to calculate at least one of a correction angle or a correction amount for a balance state with respect to the rotation shaft, based on a difference between the amount of vibration stored in the storage unit before an adjustment operation for adjusting the balance state with respect to the rotation shaft and the amount of vibration stored in the storage unit after the adjustment operation,
wherein the display control unit causes the display unit to display at least one of the difference, the correction angle, or the correction amount.

6. The machine tool according to claim 2, wherein
the motor drive unit is provided in a control device configured to control a machine main body, and
the acquisition unit and the display control unit are provided in a device configured to be separated from the control device.
